(19) United States
(12) Patent Application Publication
(10) Pub. No.: US 2007/0046575 A1
(43) Pub. Date: Mar. 1, 2007

(54) Method for Driving Plasma Display Apparatus

(75) Inventors: Byung Hyun KIM, Gumi-si, Kyungsangbuk-do (KR); Sung Im LEE, Gumi-si, Kyungsangbuk-do (KR); Kyung Ryeol SHIM, Gumi-si, Kyungsangbuk-do (KR); Yoon Chang CHOI, Milyang-si, Kyungsangnam-do (KR)

Correspondence Address: FISH & RICHARDSON P.C., P.O. BOX 1022, MINNEAPOLIS, MN, 55440-1022, US

(73) Assignee: LG ELECTRONICS INC., Youngdungpo-gu, Seoul (KR)

(21) Appl. No.: 11/276,284

(22) Filed: Feb. 22, 2006

(30) Foreign Application Priority Data
Feb. 23, 2005 (KR) 10-2005-0015169

(51) Int. Cl. G09G 3/28

(52) U.S. Cl. 345/67

(57) ABSTRACT

A method for driving a plasma display apparatus is disclosed in which a scan pulse which falls to a voltage level lower than a lower limit voltage of a ramp-down waveform applied during a set-down period is applied to a scan electrode during an address period to thereby improve jitter characteristics and enable high speed driving, and an auxiliary data pulse for sustaining a voltage lower than a bias voltage applied during a set-down period is applied to the sustain electrode during an address period to thereby compensate a voltage difference with the scan electrode to prevent an erroneous discharge.

### BACKGROUND OF THE INVENTION

1. Field of the Invention

The present invention relates to a method for driving a plasma display apparatus and, more particularly, to driving waveforms inducing a strong address discharge by controlling a lower limit voltage of a scan pulse and a method for driving a plasma display apparatus operated by the driving waveforms.

2. Description of the Related Art

A plasma display panel (PDP) is an apparatus in which discharge cells are formed between a rear substrate with barrier ribs formed thereon and a front substrate facing the rear substrate, and when an inert gas inside each discharge cell is discharged by a high frequency voltage, vacuum ultraviolet rays are generated to illuminate phosphor to thereby allow displaying of images.

The structure of the discharge cell of the PDP will now be described with reference to FIG. 1. An upper substrate 10 faces a lower substrate 18. A scan electrode (Y) and a sustain electrode (Z) are formed on the upper substrate 10, and an address electrode (X) is formed on the lower substrate 18.

The scan electrode (Y) and the sustain electrode (Z) include transparent electrodes 12Y and 12Z and metal bus electrodes 13Y and 13Z each having a smaller line width than that of the transparent electrodes, respectively.

The transparent electrodes 12Y and 12Z are made of indium-tin-oxide (ITO), and the meal bus electrodes 13Y and 13Z are made of a metal such as chrome (Cr) and serve to reduce a voltage drop due to the transparent electrodes 12X and 12Y with high resistance.

An upper dielectric layer 14 and a protective film 16 are stacked to cover the scan electrode Y and the sustain electrode Z on the upper substrate 10. Wall charges generated during a plasma discharge are accumulated on the upper dielectric layer 14, and the protective film 16 prevents damage of the upper dielectric layer 14 according to sputtering generated during the plasma discharge and increases discharge efficiency of secondary electrons.

A lower dielectric layer 22 is formed on the lower substrate 18, barrier ribs 24 are formed to prevent a leakage of ultraviolet rays and visible light generated according to the discharge to an adjacent discharge cell, and a phosphor layer 26 is coated on the surface of the lower dielectric layer 22 and the barrier ribs 24.

The phosphor layer 26 is excited by ultraviolet rays generated during the plasma discharge to generate one of red, green and blue visible light.

To implement gray levels of images, the PDP is driven by time division of one frame into several sub-fields each having a different number of times of illumination.

The method for driving the PDP will be described with reference to FIG. 2. When an image is displayed by 256 gray levels, a frame period (16.67 ms) corresponding to 1/60 seconds is divided into eight sub-fields (SF1-SF8) and each of the sub-fields is divided into a reset period for initializing a discharge cell, an address period for selecting a scan line and selecting a cell from the selected scan line, and a sustain period for implementing gray levels according to the number of times of discharge. The gray levels of an image displayed at each sub-field is increased at the rate of 2ⁿ (n=0, 1, 2, 3, 4, 5, 6 and 7).

Driving waveforms of the PDP supplied during the sub-fields will be described with reference to FIG. 3.

The reset period is divided into a set-up period and a set-down period. During the set-up period, a ramp-up waveform is applied simultaneously to every scan electrode (Y) so that a small discharge occurs in every discharge cell, and accordingly, wall charges are generated.

During the set-down period, a ramp-down waveform which falls from a positive polarity voltage lower than a peak voltage of the ramp-up waveform is simultaneously applied to every scan electrode (Y) so that an erase discharge occurs in every discharge cell, and accordingly, unnecessary charges of the wall charges and space charges generated according to a set-up discharge are erased.

During the address period, a negative polarity scan pulse (scan) is sequentially applied to the scan electrode (Y) and, at the same time, a positive polarity data pulse (data) is applied to the address electrode (X). A voltage difference between the scan pulse (scan) and the data pulse (data) and a wall voltage generated during the reset period make an address discharge occur and a cell is selected.

A signal for sustaining a sustain voltage level (Vs) is applied to the sustain electrode (Z) during the set-down period and the address period.

During the sustain period, a sustain pulse (sus) is alternately applied to the scan electrode (Y) and the sustain electrode (Z) to generate a sustain discharge in a surface discharge form between the scan electrode (Y) and the sustain electrode (Z). When the sustain discharge is completed, a ramp waveform (erase) for erasing the wall charges is supplied to the sustain electrode (Z).

A principle of generation of the wall charges and discharges in each discharge cell according to driving waveforms as shown in FIG. 3 will now be described in detail by using a hexagonal voltage curve (Vt close curve) as shown in FIG. 4. Here, the voltage curve (Vt close curve) is used to exhibit the principle of generation of the discharge in the panel and measure a voltage margin.

The interior region of the hexagonal voltage curve is where the wall charges are distributed within the discharge cell and no discharge occurs in the region. Y(−) indicates a change in a wall voltage when a negative polarity voltage is applied to the scan electrode (Y), and likewise, Y(+), X(+), X(−), Z(+) and Z(−) indicate a change in the wall voltage when a negative or positive polarity voltage is applied to the scan electrode (Y) or the sustain electrode (Z), respectively.

Wall charge conditions are not uniform in every discharge cell at a first sub-field of one frame. Thus, in order to make the wall charge conditions in cells uniform, a ramp-up waveform with a voltage value which rises from the positive polarity voltage up to beyond a discharge firing voltage is applied to the scan electrode (Y) during the set-up period.

Accordingly, as shown in FIG. 5, it reaches a discharge boundary region between the scan electrode (Y) and the sustain electrode (Z) of a third quadrant of the discharge curve, generating the discharge, and at this time, a wall voltage is moved from a point A0, namely, an initial wall voltage point, to a point C1 at the slope of ½ by wall charges formed in the scan electrode (Y) and the sustain electrode (Z).

Thereafter, when the voltage value is continuously increased, the cell voltage is decreased to reach a point ‘F’, so a facing discharge occurs also between the scan electrode (Y) and the address electrode (X). In addition, since wall charges are generated also in the address electrode (X), the wall voltage is changed from the point C1 to a point C2 at a slope of 1.

In a state that the cell voltage has been moved from the point ‘F’ to a point A1 by the ramp-up waveform, a ramp-down waveform is applied to the scan electrode (Y) during the set-down period.

With reference to FIG. 6, the cell voltage is changed in a Y(−) direction by the ramp-down waveform and when it reaches a point A2, namely, a surface discharge firing voltage between the scan electrode (Y) and the sustain electrode (Z), a discharge occurs. Then, the wall voltage is changed from the point C2 to a point C3 at the slope of ½according to the generated discharge.

When the cell voltage is continuously moved along a surface discharge region of a first quadrant and reaches a point F2 according to the ramp-down waveform, a discharge occurs also between the scan electrode (Y) and the address electrode (X). Since wall charges are generated in the address electrode (X) according to the facing discharge, the wall voltage is changed from the point C3 to a point C4 at the slope of 1. Namely, the wall voltage is initialized to a state of around A0 by the ramp-up waveform and the ramp-down waveform applied during the reset period.

During the address period that follows the reset period, the scan pulse (scan) is applied to the scan electrode (Y) and the data pulse (data) is applied to the address electrode (X). In addition, a positive polarity bias voltage is applied to the sustain electrode (Z). Accordingly, as shown in FIG. 7, the cell voltage is changed to a point A3 according to the sum of the amount of a change moving in the Y(−) direction by the scan pulse (scan), the amount of a change moving in the X(+) direction by the data pulse (data) and the amount of a change moving in the Z(+) direction by the positive polarity bias voltage applied to the sustain electrode (Z), to generate the discharge.

During the sustain period that follows the address period, as shown in FIGS. 8 and 9, the positive polarity sustain pulse starts to be applied to the scan electrode (Y), and it is alternately applied to the scan electrode (Y) and the sustain electrode (Z).

As shown in FIG. 8, the cell voltage is moved in the Y(+) direction by the sustain pulse (sus) applied to the scan electrode (Y) to exceed the surface discharge firing voltage, generating the surface discharge between the scan electrode (Y) and the sustain electrode (Z), and as the polarity of the wall voltage is reversed by the wall charges formed between the scan electrode (Y) and the sustain electrode (Z), the wall voltage is moved to a point C6.

In the state that the wall voltage is positioned at the point C6, when the sustain pulse (sus) is applied to the sustain electrode (Z), as shown in FIG. 9, the cell voltage is moved in the Z(+) direction to exceed the surface discharge firing voltage, generating a discharge, and the wall voltage is moved to a point C7.

As for the driving waveforms for generating the discharges during the above-described process, the address discharge occurs as the cell voltage is changed to the corner portion (near point A3) as shown in FIG. 7. In this respect, for a stable discharge, time for applying the scan pulse, namely, a scan pulse width, must be secured, but a problem arises that the more the scan pulse width increases, the longer time required for scanning increases.

Recently, as the panel is enlarged in size, a dual scanning method for performing scanning by dividing a screen into two parts is employed due to the insufficient scanning time. However, since the dual scanning method requires two data drivers, a fabrication cost increases. Thus, in order to employ a single scanning method instead to reduce the fabrication cost, a high speed driving method for reducing the scanning time is necessary.

### SUMMARY OF THE INVENTION

The present invention is designed to solve such a problem of the related art, and therefore, an object of the present invention is to provide a method for driving a plasma display apparatus capable of driving (operating) a plasma display apparatus at a high speed by reducing the width of a scan pulse.

To achieve the above object, there is provided a method for driving a plasma display apparatus wherein a sub-field for driving discharge cells formed at each crossing of at least one or more scan electrodes and sustain electrodes formed on an upper substrate and at least one or more address electrodes formed on a lower substrate is divided into one or more of a reset period, an address period and a sustain period. The reset period is divided into a set-up period during which a waveform which rises up to a positive polarity upper limit voltage is applied to the scan electrode and a set-down period during which a waveform which falls to a negative polarity first voltage is applied to the scan electrode, and at the same time, a positive polarity third voltage is applied as a bias voltage to the sustain electrode. During the address period, a scan pulse which falls to a second voltage lower than the first voltage is applied to the scan electrode and a waveform sustaining a fourth voltage lower than the third voltage is applied to the sustain electrode.

The waveform applied to the scan electrode during the set-up period rises gradually up to the upper limit voltage from a sustain voltage level, and in this case, the positive polarity upper limit voltage is higher than a discharge firing voltage.

During the set-down period, the waveform which falls to the first voltage from the upper limit voltage by at least one or more steps is applied to the scan electrode and the positive polarity third voltage is applied as the bias voltage to the sustain electrode.

During the address period, as the scan pulse which falls to the second voltage lower than the first voltage is applied to the scan electrode, the fourth voltage lower than the third voltage is applied also to the sustain electrode, to thereby sustain a certain level of a voltage difference between the both electrodes. In addition, a data pulse in synchronization with the scan pulse is applied to the address electrode.

Thus, the fourth voltage is a positive or negative polarity voltage, and its absolute value may be greater than a ground voltage but not greater than an absolute value of the third voltage.

During the sustain period, the sustain pulse is alternately applied to the scan electrode and the sustain electrode.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing the structure of a discharge cell of a plasma display panel in accordance with a related art.

FIG. 2 illustrates a frame of the plasma display panel.

FIG. 3 shows driving waveforms applied to electrodes during a sub-field period in accordance with the related art.

FIG. 4 shows a wall charge in a discharge cell.

FIGS. 5 to 9 show positions of wall charges in the discharge cell according to occurrence of discharges.

FIG. 10 shows driving waveforms applied to electrodes during the sub-field period in accordance with the present invention.

FIGS. 11 to 15 show positions of wall charges in the discharge cell according to occurrence of discharges.

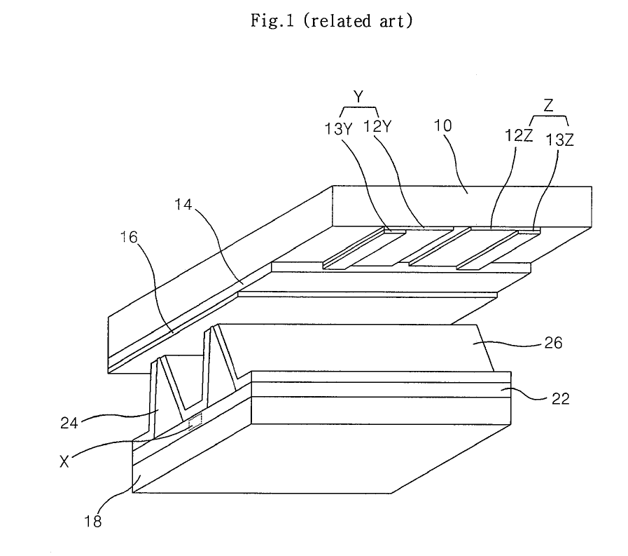

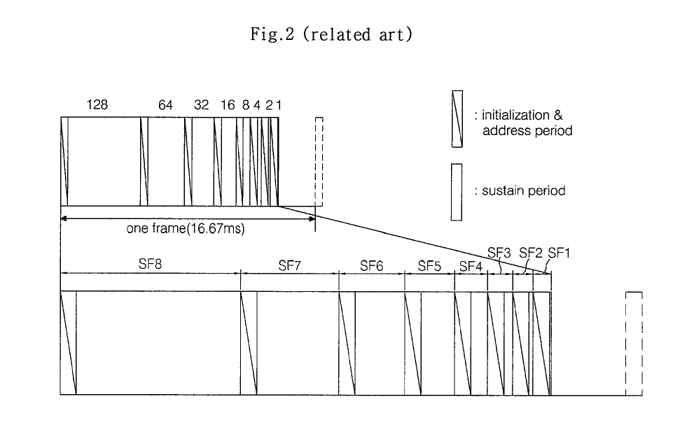

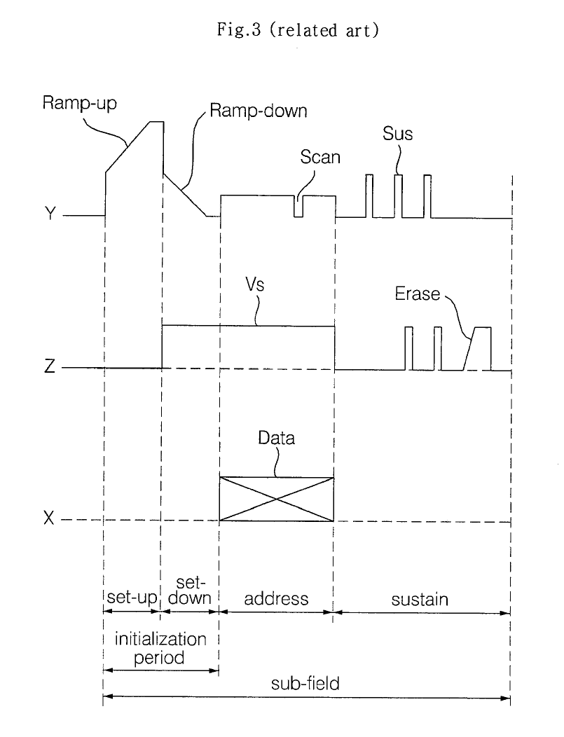

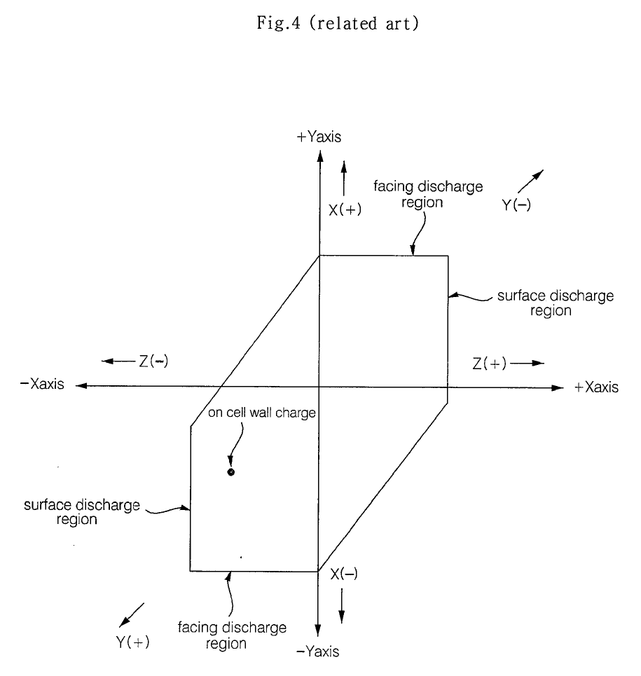

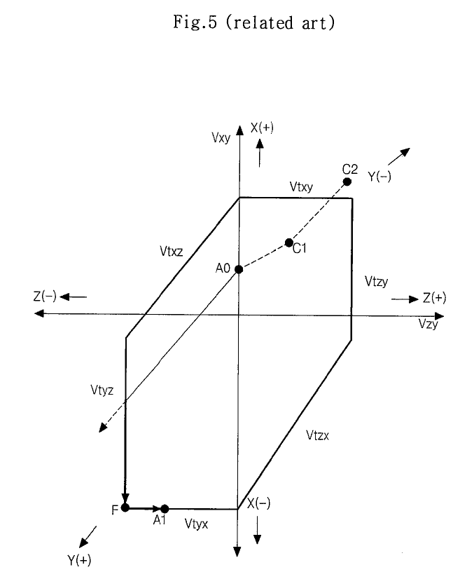

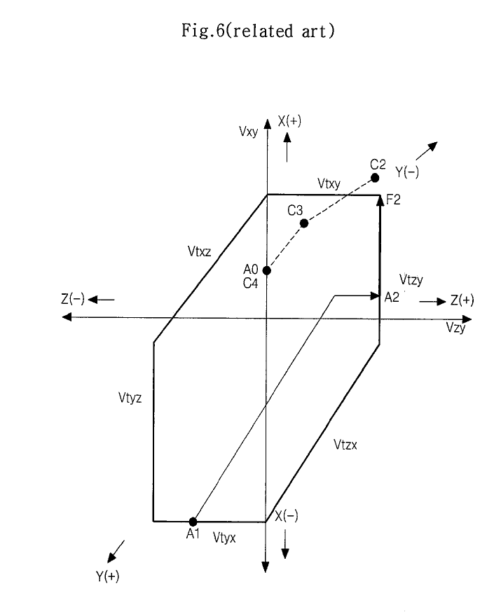

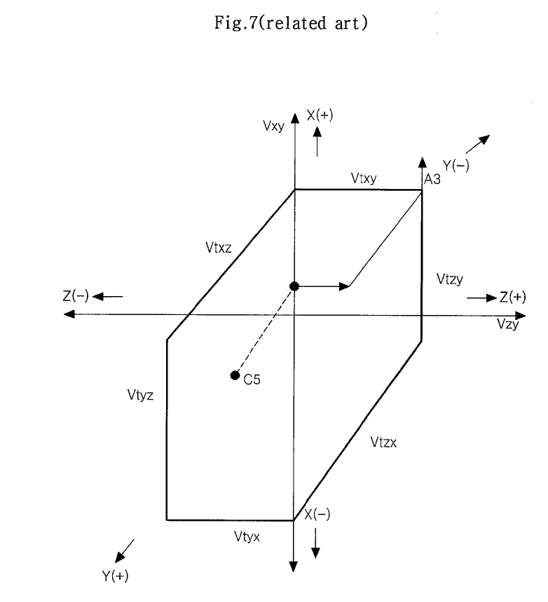

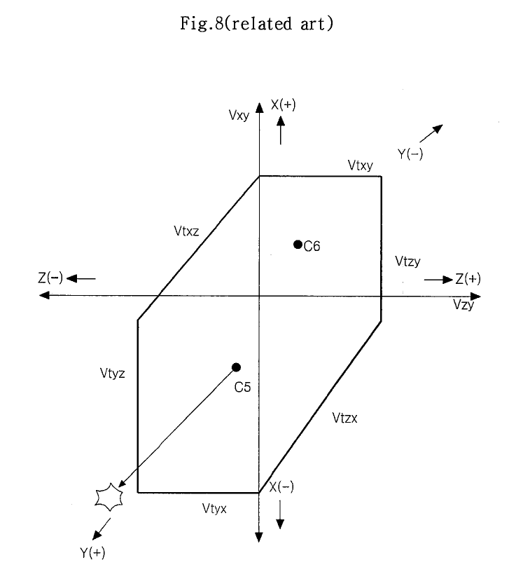

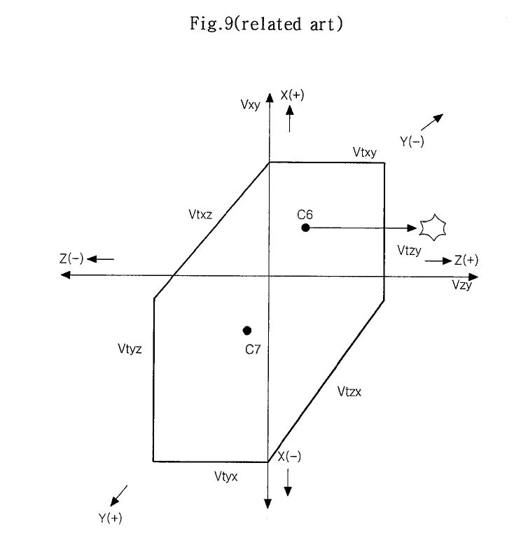

### DETAILED DESCRIPTION OF THE PREFERRED EMBODIMENT

The method for driving a plasma display apparatus at a high speed by setting a lower limit voltage of a scan pulse lower than that of a related art and reducing the width of the scan pulse in accordance with the present invention will be described with reference to the accompanying drawings.

There can be a plurality of embodiments of a plasma display panel (PDP) in accordance with the present invention without being limited to those described in the present invention.

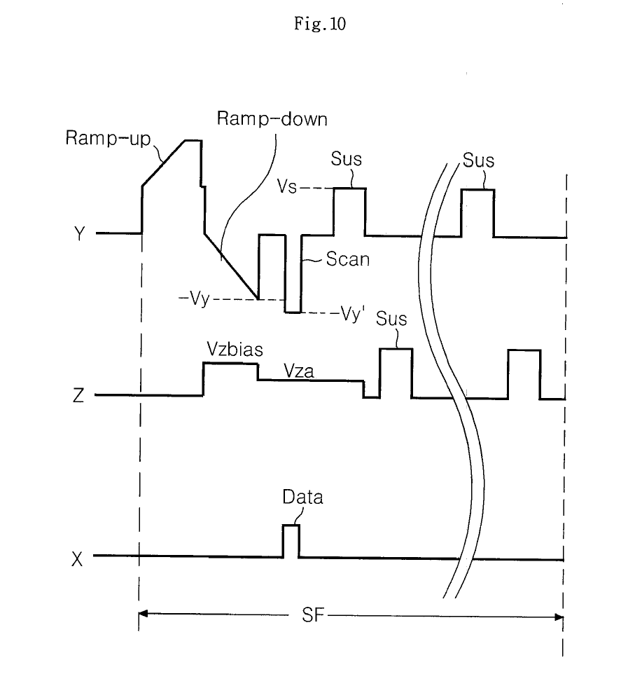

The embodiment of the present invention will now be described in detail with reference to FIGS. 10 to 15.

FIG. 10 is a driving waveform view showing a method for driving PDP in accordance with the present invention.

First, the PDP includes an upper substrate, on which at least one or more scan electrodes and sustain electrodes are formed, and a lower substrate, on which at least one or more address electrodes are formed, facing the upper substrate.

A sub-field for driving a discharge cell formed at each crossing of the electrodes formed on the upper and lower substrates includes one or more of a reset period for initializing an entire screen, an address period for selecting cells, and a sustain period for sustaining discharges of the selected cells.

The reset period is divided into a set-up period and a set-down period. A waveform which rises up to a positive polarity upper limit voltage during the set-up period and falls to a negative polarity first voltage during the set-down period is applied to every scan electrode (Y).

During the set-up period, a weak discharge occurs within discharge cells of the entire screen by a ramp-up waveform which continuously rises up to the upper limit voltage from a sustain voltage, so wall charges are generated within the cells.

During the set-down period, a ramp-down waveform which falls to a ground level from the upper limit voltage and then continuously falls to the first voltage (−Vy) is applied to the scan electrode (Y). Accordingly, a weak erase discharge occurs in the discharge cells to erase the wall charges and space charges generated by the set-up discharge, so that wall charges required for an address discharge can remain uniformly in the cells of the entire screen.

At the same time, a positive polarity third voltage, which is called a sustain bias voltage (Vzbias), is applied to the sustain electrode (Z) during the set-down period. That is, during the reset period, the set-up discharge and the set-down discharge occur due to the voltage difference between the scan electrode (Y) and the sustain electrode (Z).

During the address period, a negative polarity scan pulse (scan) is sequentially applied to the scan electrode (Y). The scan pulse (scan) falls down to a second voltage (−Vy') lower than the first voltage (−Vy). At the same time, a positive polarity data pulse (data) is applied to the address electrode (X) and a positive polarity fourth voltage (Vza) lower than the third voltage (Vzbias) is applied to the sustain electrode.

An absolute value of the fourth voltage (Vza) is greater than the ground level, and an absolute value of a voltage value of a sustain bias pulse, namely, an auxiliary data pulse, is greater than the ground level but equal to or smaller than the sustain bias voltage (Vzbias).

When the voltage difference between the scan electrode (Y) and the address electrode (X) according to the application of the scan pulse (scan) and the data pulse (data) and the wall voltage generated during the reset period are added, the address discharge occurs within the cells to which the data pulse (data) is applied.

During the sustain period, a sustain pulse (sus) is alternately applied to the scan electrode (Y) and the sustain electrode (Z). Accordingly, in the cells selected by the address discharge, a sustain discharge occurs as the wall voltage within the cells and the voltage difference between the electrodes according to the application of the sustain pulse are added.

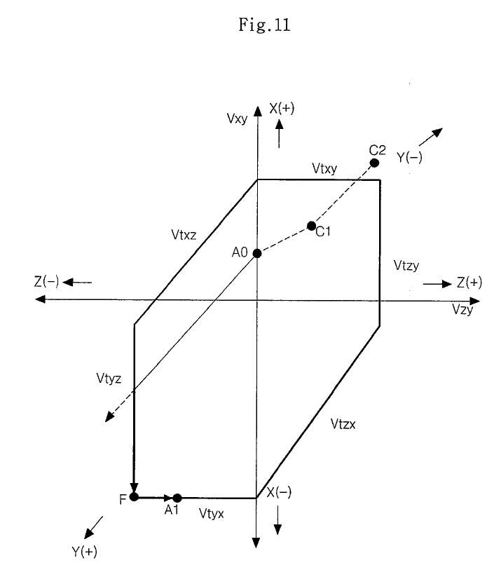

The principle of the discharge according to the driving waveforms will now be described in detail by using the voltage curve as shown in FIGS. 11 to 15.

Because wall charge conditions are not uniform in each discharge cell, in order to make the wall charge conditions uniform, a waveform which continuously rises from a positive polarity voltage up to the upper limit voltage higher than a discharge firing voltage is applied to the scan electrode (Y) during the reset period of a first sub-field of one frame.

Accordingly, as shown in FIG. 11, it reaches a discharge boundary region between the scan electrode (Y) and the sustain electrode (Z) of a third quadrant of a discharge curve, generating a discharge, and at this time, a wall voltage is moved from a point A0, namely, an initial wall voltage point, to a point C1 at a slope of ½ by wall charges formed in the scan electrode (Y) and the sustain electrode (Z).

Thereafter, when the voltage value is continuously increased, a cell voltage is decreased to reach a point ‘F’, so a facing discharge occurs between the scan electrode (Y) and the address electrode (X). In addition, since wall charges are generated also in the address electrode (X), the wall voltage is changed from the point C1 to a point C2 at a slope of 1.

In a state that the cell voltage has been moved from the point ‘F’ to a point A1 according to an increase in the voltage of the scan electrode (Y) during the set-up period, a ramp-down waveform which falls from the upper limit voltage to the first voltage (−Vy) is applied to the scan electrode (Y) and a waveform for sustaining a third voltage as a bias voltage (Vzbias) is applied to the sustain electrode (Z) during the set-down period.

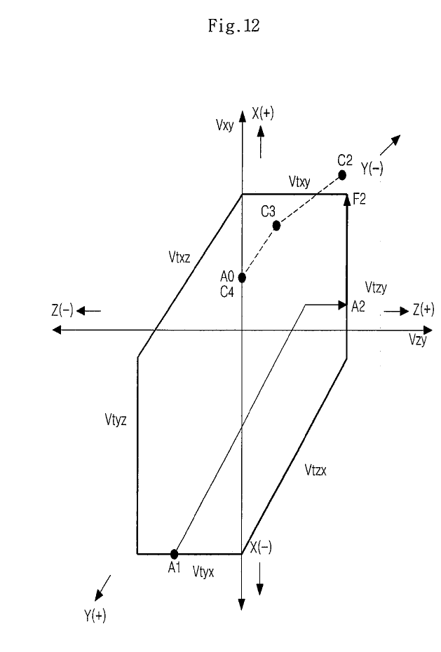

With reference to FIG. 12, the moment the cell voltage reaches a point A2, namely, a surface discharge firing voltage between the scan electrode (Y) and the sustain electrode (Z), after being changed in a Y(−) direction by the ramp-down waveform which falls to the negative polarity first voltage (−Vy), a discharge occurs, and at this time, the wall voltage is changed from the point C2 to a point C3 at the slope of ½ according to the generated discharge.

When the cell voltage is continuously moved along a surface discharge region of a first quadrant and reaches a point F2 according to the ramp-down waveform, a discharge occurs also between the scan electrode (Y) and the address electrode (Y). Since wall charges are generated also in the address electrode (X) according to the facing discharge, the wall voltage is changed from the point C3 to a point C4 at the slope of 1. Namely, the wall voltage is initialized to a state of around A0 by the ramp-up waveform which generates the set-up discharge and the ramp-down waveform which generates the set-down discharge during the reset period.

During the address period that follows the reset period, the scan pulse (scan) is applied to the scan electrode (Y) and the data pulse (data) is applied to the address electrode (X). In addition, a positive polarity voltage (Vza) is applied to the sustain electrode (Z).

In this case, the scan pulse (scan) applied to the scan electrode (Y) during the address period falls to the second voltage (−Vy') lower than the first voltage (−Vy), namely, the lower limit voltage of the ramp-down waveform applied during the set-down period. And the pulse (Vza) applied to the sustain electrode (Z) sustains the fourth voltage (Vza) lower than the third voltage (Vzbias), namely, the bias voltage applied during the set-down period. The waveform sustaining the fourth voltage is called an auxiliary data pulse.

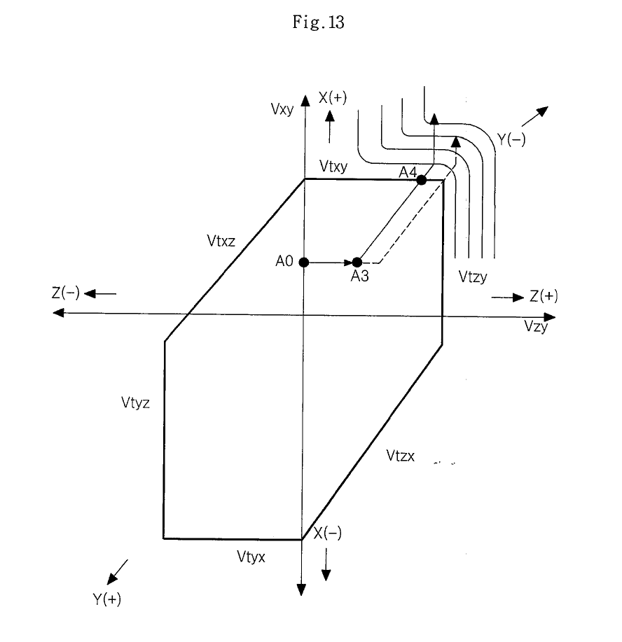

Accordingly, as shown in FIG. 13, in a state that the cell voltage has been moved in the Z(+) direction by the auxiliary data pulse (Vza) applied to the sustain electrode (Z) and thus changed to a point A3, the cell voltage is changed to a point A4 according to the sum of the amount of a change moving in the Y(−) direction by the scan pulse (scan) and the amount of a change moving in the X(+) direction by the data pulse, generating the address discharge.

In this case, the reason why the lower limit voltage of the scan pulse (scan) is lower than that of the related art is to improve the jitter characteristics, namely, the characteristics related to how quickly the discharge can be initiated (fired) at a time point when the scan pulse (scan) and the data pulse (data) are applied.

Substantially, although the voltage difference between both electrodes exceeds the discharge firing voltage, discharges do not occur immediately but with some delay time due to a discharge delay. The delay time causes a delay of discharge driving, so the shorter the delay time, the faster scanning can be performed.

Thus, in order to improve the jitter characteristics, in the present invention, the lower limit voltage of the scan pulse (scan) is set as the second voltage (−Vy') which is lower than the first voltage (−Vy) and the width of the scan pulse is reduced compared with that of the related art. In this respect, however, if the voltage difference between the sustain electrode (Z) and the scan electrode (Y) to which the scan pulse (scan) is applied is high, the address discharge may occur even in a cell which is to be designated as an OFF cell. Thus, in order to prevent occurrence of such an erroneous discharge, in the present invention, the voltage value of the auxiliary data pulse applied to the sustain electrode (Z) is set as the fourth voltage (Vza) which is lower than the third voltage (Vzbias).

Referring to the discharge voltage curve as shown in FIG. 13 in connection with the jitter characteristics, the equal curved lines shown at an edge portion of the first quadrant indicate a discharge range, and in this case, the farther a curved line exists from outside the discharge voltage curved line, the stronger discharge occurs there and it is a boundary with good jitter characteristics.

As shown in FIG. 13, as for a discharge occurring at the discharge cell driven by the driving waveforms of the related art, the cell voltage is changed to the point where the discharge occurs weak as indicated by a dotted line, so the jitter characteristics is not good. Comparatively, in the present invention, as for the discharge occurring in the discharge cell driven by the driving waveforms in accordance with the present invention, since the cell voltage is changed to the point where the strong discharge occurs as indicated by a solid line, the jitter characteristics can be improved.

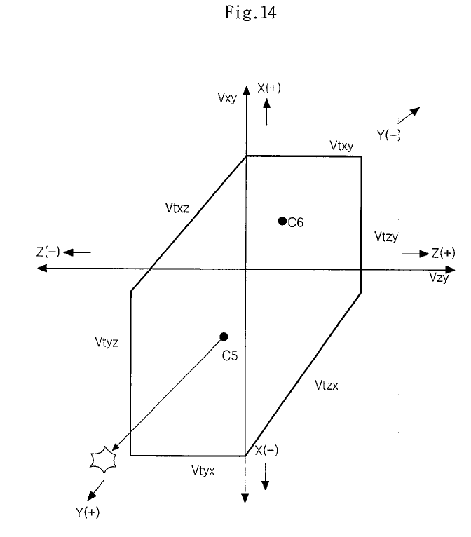

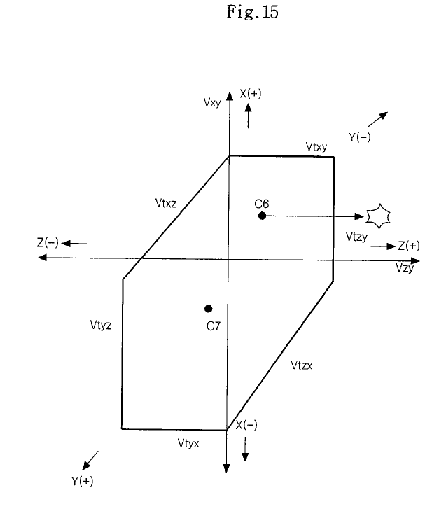

During the sustain period that follows the address period, as shown in FIGS. 14 and 15, the sustain pulse is alternately applied to the scan electrode (Y) and the sustain electrode (Z).

With reference to FIG. 14, as the cell voltage is moved in the Y(+) direction by the sustain pulse (sus) applied to the scan electrode (Y) and exceeds the surface discharge firing voltage, the surface discharge occurs between the scan electrode (Y) and the sustain electrode (Z), and as the polarity of the wall voltage is reversed by the wall charges formed between the scan electrode (Y) and the sustain electrode (Z), the wall voltage is moved to a point C6.

With the wall voltage positioned at the point C6, when the sustain pulse (sus) is applied to the sustain electrode (Z), as shown in FIG. 15, the cell voltage is moved in the Z(+) direction to exceed the surface discharge firing voltage, so the sustain discharge occurs and the wall voltage is moved to a point C7.

In this manner, the scanning time can be shortened by the driving waveforms in accordance with the present invention, thus enabling a high speed addressing. Therefore, although the size of the panel is increased, the single scanning method can be employed and thus the fabrication cost can be reduced.

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto and their equivalents.

What is claimed is:

1. A method for driving a plasma display apparatus wherein a sub-field for driving discharge cells formed at each crossing of at least one or more scan electrodes and sustain electrodes formed on an upper substrate and at least one or more address electrodes formed on a lower substrate comprises one or more of a reset period, an address period and a sustain period,
the reset period comprises a set-up period during which a waveform which rises up to a positive polarity upper limit voltage is applied to the scan electrode and a set-down period during which a waveform which falls to a negative polarity first voltage is applied to the scan electrode, and a positive polarity third voltage is applied as a bias voltage to the sustain electrode, and
during the address period, a scan pulse which falls to a second voltage lower than the first voltage is applied to the scan electrode and a waveform sustaining a fourth voltage lower than the third voltage is applied to the sustain electrode.

2. The method of claim 1, wherein a data pulse in synchronization with the scan pulse is applied to the address electrode during the address period.

3. The method of claim 1, wherein the fourth voltage is a positive or negative polarity voltage.

4. The method of claim 1, wherein an absolute value of the fourth voltage is greater than a ground voltage and equal or less than an absolute value of the third voltage.

5. The method of claim 1, wherein the positive polarity upper limit voltage is higher than a discharge firing voltage, and a waveform which rises gradually up to the upper limit voltage from a sustain voltage level is applied during the set-up period.

6. The method of claim 1, wherein a waveform which falls to the first voltage from the upper limit voltage by at least one or more steps is applied during the set-down period.

7. The method of claim 1, wherein a sustain pulse is alternately applied to the scan electrode and the sustain electrode during the sustain period.

8. A method for driving a plasma display apparatus wherein a sub-field for driving discharge cells formed at each crossing of at least one or more scan electrodes and sustain electrodes formed on an upper substrate and at least one or more address electrodes formed on a lower substrate comprises one or more of a reset period, an address period and a sustain period,
waveforms applied to the scan electrode comprise a reset waveform which rises up to an upper limit voltage and then falls to a first voltage during the reset period and a scan pulse waveform which falls from a scan bias voltage to a second voltage lower than the first voltage during the address period, and of a waveform applied to the sustain electrode, a third voltage applied during the reset period and a fourth voltage applied during the address period have each different level.

9. The method of claim 8, wherein the waveforms applied to the scan electrode and the sustain electrode comprise a sustain pulse waveform having a sustain bias voltage and a sustain voltage as repeated during the sustain period.

10. The method of claim 8, wherein a waveform applied to the address electrode is a data pulse which rises up to a positive polarity voltage in synchronization with the scan pulse during the address period.

11. The method of claim 8, wherein an absolute value of the fourth voltage is greater than a ground voltage but not greater than an absolute value of the third voltage.

12. The method of claim 8, wherein the positive polarity upper limit voltage is higher than a discharge firing voltage, and a waveform which rises gradually up to the upper limit voltage from a sustain voltage level is applied during the set-up period.

13. The method of claim 8, wherein the waveform falls to the first voltage from the upper limit voltage by at least one or more steps during the reset period.

14. A method for driving a plasma display apparatus wherein driving waveforms applied to at least one or more of a scan electrode, a sustain electrode and an address electrode formed on a panel are divided by sub-fields each comprising at least one or more of a reset period comprising a set-up period and a set-down period, an address period and a sustain period, and
a third voltage applied to the sustain electrode during the set-down period is higher than a fourth voltage applied during the address period.

15. The method of claim 14, wherein a scan pulse, which rises up to a positive polarity upper limit voltage during the set-up period, falls to a negative polarity first voltage by at least one or more steps during the set-down period, and falls to a second voltage lower than the first voltage during the address period, is applied to the scan electrode.

16. The method of claim 15, wherein a data pulse which rises up to a positive polarity voltage in synchronization with the scan pulse is applied to the address electrode during the address period.

17. The method of claim 14, wherein a sustain pulse is alternately applied to the scan electrode and the sustain electrode during the sustain period.
